(19) United States
(12) Patent Application Publication
(10) Pub. No.: US 2023/0416117 A1
(43) Pub. Date: Dec. 28, 2023

(54) Air recovery system

(71) Applicant: Oliver James Groves, Freeland, WA (US)

(72) Inventor: Oliver James Groves, Freeland, WA (US)

(21) Appl. No.: 17/803,398

(22) Filed: Jun. 24, 2022

(51) Int. Cl. C02F 1/04; C02F 1/00; C02F 1/18; C02F 1/14

(52) U.S. Cl. CPC C02F 1/048; C02F 1/001; C02F 1/18; C02F 1/14; C02F 1/043; C02F 2103/08

(57) ABSTRACT

An air recovery system, comprising: a) a water source that is capable to delivering a water source to the atmospheric tank. b). an atmospheric tank assembly that provides a heat exchanger to heat the water source inside the copper tubing and condenses the hot water vapor back into water. c) Two vacuum tank assemblies that receives hot water and under both a vacuum pressure and a temperature provides hot water vapor. d). Two CP-150 CLAWVAC vacuum pumps that remove the hot water vapor for the respective vacuum tanks. e). The water purification CP-150 CLAWVAC vacuum pump delivers the hot water vapor to the atmospheric tank and provides water. f).The air recovery vacuum tank assembly delivers the hot water vapor to the atmosphere. g).Both vacuum tank assemblies are connected to a solar water collector. H).Both vacuum tank assemblies are connected to a salt recovery system. i).The portable brine tank container connects to the water purification salt recovery system. Both the water purification and the air recovery systems use the atmospheric tank that connects to the clean tank assembly and UN-Compliant tank (transferable stowage water tank).

### TECHNICAL FIELD

The present application, in some embodiments thereof, relates to air recovery system to recover H₂O air from Brine solution or from seawater or raw water.

### BACKGROUND

The need for clean energy especially air and water availability has always been an environmental issue throughout the world. Contaminated air and water is especially a problem with carbon emissions and greenhouse gasses causing our planet to heat up reducing the moisture in our atmosphere. Therefore, there exists a need for an efficient, low energy air recovery system requiring a minimal amount of maintenance. Brine is a solution of water and salt, in which salt is at least 26% of the solution by weight. Water is a byproduct of the brine water desalination systems and may be thrown away. However, the salt and water can be reused as well as the water can be converted into water vapor and released into the atmosphere. In addition, the water vapor can be converted into water for drinking. There are (2) additional patents incorporated into the air recovery system. The (WPS) water purification System U.S. Pat. No. 11,247,927 B1 Feb. 15, 2022 and Salt Recovery System (U.S. Pat. No. 11,331,592 B1 May 17, 2022).

### BRIEF SUMMARY OF THE INVENTION

An aim of the system of the present invention is to provide the air recovery system that operates with the water purification system and the salt recovery system that separates the water from the brine, considered a contaminated water source, consisting of seawater and or raw water. Similar to a desalination process where the air recovery system and water purification systems both encompass vacuum pressures, heating elements and a cooling system or a heat exchanger used to transfer the hot water vapor into the atmosphere or for creating additional water. Inside the atmospheric vacuum tank assembly is where the hot water vapor is created and released into the atmosphere by the CP-150 CLAWVAC vacuum pump or a similar vacuum pump. The brine tank located below and connected to the atmospheric vacuum tank assembly is where the brine is created and accumulated by the vaporization process, brine solution weighing more than water accumulates at the bottom of the tank. After a period of time when the brine tank is full the brine is transferred into the salt recovery system where the salt is separated from the brine solution. The water vapor may be recycled and used for a variety of functions, such as releasing the hot water vapor into the atmosphere or by transferring the hot water vapor into a greenhouse or used for vertical farming providing a moist atmosphere.

The water purification system is used with the clean tank assembly to supply ample fresh water when needed for drinking or for watering plants. In addition, converting the hot water vapor back into water can be accomplished by recirculating the hot water vapor back into the atmospheric tank and using the heat exchanger to cool the hot water vapor changing the water back in to liquid water. The water is pumped into the clean tank assembly where the water is exposed to ultraviolet (UV) sterilizer and flows through a plurality of ion filters and then pumped into the UN-compliant tank (transferable stowage water tank).

Therefore, an aspect of some embodiments of the present invention relates to the air recovery system combined with a water purification system, salt recovery system, solar water collectors, clean tank assembly, atmospheric vacuum tank assembly, portable brine tank container and an UN-compliant tank (transferable stowage tank). Furthermore, a water source such as seawater and raw water pump supply system. The air recovery system and all the other associated systems can be powered by an off-grid solar panel system.

The Invariant, Shown in FIG. 1 block diagram. The water purification system comprising of (10) ten portable modules combined with a water source retrieval system, providing a water source to the air recovery system and the water purification system will depending on the distance from the water source may require additional water pumps and stowage tanks for transferring the water source from one water pump and stowage tank to the next water pump and stowage tank.

The Invariant, (WPS) water purification system described in the patent U.S. Pat. No. 11,247,927 B1 comprising of the major components: two (1) CP-150 CLAWVAC vacuum pump with pumping speeds 150/180 (m³/h). And (1) one high vacuum pump with a pumping capacity of 0.1 micron (1 Torr-10⁻³ Torr) and a pumping speed of 3.5 CFM, a vacuum tank assembly needed to start the produce for hot water vapor, an atmospheric tank used to convert hot water vapor into water and a brine tank located below the vacuum tank assembly for collecting the brine solution and processing the brine through the salt recovery system.

The Invariant, FIG. 4 is the air recovery system comprising of the following components: one (1) CP-150 CLAWVAC vacuum pumps with pumping speeds 150/180 (m³/h). One (1) atmospheric vacuum tank assembly comprising of two (2) heating elements, one (1) level indicator, two (2) liquid sight glass windows, one (1) vacuum relief valve and one (1) exhaust port for over pressurization by the atmosphere due to excess water, Two (2) thermostat's one for each heating element, two (2) ball valves with 10 micron filters and a flow control valve that connects to each end of the vacuum tank for supplying water, one micron gauge connected to the vacuum tank, one (1) high vacuum pump with a pumping capacity of 0.1 micron (1 Torr-10⁻³ Torr) and a pumping speed of 3.5 CFM and one (1) water stowage tank for the exhaust hot water vapor from the Torr vacuum pump and comprising of a brine tank located below the vacuum tank for collecting brine solution. Exhaust silencers used when warming up the CP-150 CLAWVAC vacuum pump and for exhausting the hot water vapor into the atmosphere.

In another Invariant, the air recovery system, encompasses the atmospheric vacuum tank assembly and the CP-150 CLAWVAC vacuum pump used for releasing hot moist air into the atmosphere as well as releasing the moist air into a greenhouse and can be used for vertical farming. The air recovery system has been integrated into the water purification system for suppling hot water and having a salt recovery system for processing the brine solution into hot water vapor and salt.

In an invariant, system 100 encompassing the water source supply, salvage water pump and seawater stowage tank can be uses multiple times inline base on the distance from the water source to the air recovery system installation.

In an invariant, each solar hot water collector supplies a continuous flow of hot water to the vacuum tanks by a water pump reducing the electrical requirements for operating the (2) two heating elements controlled by the (2) two thermostats in the atmospheric vacuum tank chamber.

In an invariant, the salt recovery system receives brine from the water purification system brine tank assembly and the portable brine transport container and separates the water from the salt.

The invariant, clean tank assembly is used upstream of the water purification system to expose the water to ultraviolet treatment (UV) and filter the water using an ion exchange system and flows into a holding tank where water test is then performed are subjected to meeting pH7 level standards. After testing, the water flows into the UN-compliant tank transferable stowage water tank.

The invariant, Portable Brine Transport container is incorporated into the water purification system configuration.

The invariant, the UN-Compliant tank (Transferable water stowage tank) is incorporated into both the air recovery system and the water purification system configuration.

The invariant, atmospheric vacuum tank assembly has over 15 times the increased water surface area than the WPS vacuum tank allowing for more hot water vapor to be released into the atmosphere.

In yet another invariant, the air recovery system allows hot moist water vapor to be released into the atmosphere. Because water acts like a detergent similar to removing particles from inside a hydraulic tube, water vapor can also be used to remove carbon and other particles from the atmosphere. The amount of water vapor exhausted into the atmosphere is based on the CP-150 CLAWVAC vacuum pump speed and/or capacity which is capable of producing up to 180³ m/h^{+0/-30m/h} equivalent to a maximum of 6,356 ft³/h.

In some embodiments of the present invention, by replenishing and adding water vapor content to the atmosphere it becomes possible and thereby beneficial to reducing carbon emissions and/or greenhouse gasses and helps in preventing droughts. New clean air generated by the air recovery system will reduce or lower emissions thereby lower the risk of climate change.

### A Micron Gauge

Intense, world-changing weather events-extreme floods, enormous wildfires, huge hurricanes, and unprecedented heat waves-are driving home a sobering reality.

Greenhouse gasses, primarily waste emissions collecting in the atmosphere and causing the planet to heat up. Already the planet has warmed up more than one degree Celsius (1.8 degrees Fahrenheit) since the preindustrial period in the 18002. This is the cause of the exacerbating extreme weather events, hotter heat waves, more severe droughts, and cascades of changes-sea level rise-as an example-that are irreversible to human time scale.

### Scientists Warn of Severe and Widespread Drought in the 21^{st} Century.

Drought is among the most hazards in the world, often carrying severe losses of agriculture, ecosystems and human societies.

With raising temperatures, everywhere there's increasing demand of moisture from the atmosphere, and precipitation decrease over subtropical regions.

These are the main driver of the projected widespread and increasing drought. Said ZHAO.

Reference CM1P6 Model Projected
Tianbao Zhao and Aiguo Dai January 2022
Journal of Climate

### BRIEF DESCRIPTION OF DRAWINGS

FIG. 1 is a block diagram illustrating (10) ten different modules associated with the air recovery system. Described in paragraph {0005}.

FIG. 2 is a block diagram illustrating the air recovery system combined with the water recovery system and the pathways describing how the air recovery system operates. The system depicts seawater pumped through a suction filter through a salvage water pump into a stowage tank. The seawater is transferred through the atmospheric tank heat exchanger. The hot water leaving the heat exchanger is separated into two different pathways one going to the water purification vacuum tank and seawater flowing to the air recovery water pump. The seawater is then pumped into both ends of the atmospheric vacuum tank. The temperature is controlled by the thermostats shown in FIG. 4 and FIG. 12. The vacuum tank encompasses a 1 Torr high vacuum pump. The 1 Torr high vacuum pump is turned on removing the atmosphere to approximately l Torr or 0.1 micron. Once the atmosphere and the temperature has been reached hot water vapor is created. The 1 Torr high vacuum pump ball valve is closed. The CP-150 CLAWVAC ball valve is opened transferring the hot water vapor through the CP-150 CLAWVAC vacuum pump releasing hot water vapor through a silencer into the atmosphere.

The water purification system operates similar to the air recovery system except when the hot water leaves the atmospheric tank heat exchanger the seawater flows through a 10-micron filter, flow control valve and a ball valve into the vacuum chamber. The temperature is controlled by the thermostats shown in FIG. 4. The vacuum tank encompasses a 1 Torr high vacuum pump. The 1 Torr high vacuum pump is turned on removing the atmosphere to approximately l Torr or 0.1 micron. Once the atmosphere and the temperature have been reached hot water vapor is created. The 1 Torr high vacuum pump ball valve is closed. The CP-150 CLAWVAC ball valve is opened transferring the hot water vapor through the CP-150 CLAWVAC vacuum pump releasing hot water vapor through an inline silencer into the atmospheric tank heat exchanger where the hot water vapor is cooled and condenses back into water. The water is then pumped into the clean tank assembly. As described in the water purification system patent U.S. Pat. No. 11,247,927 B1 Feb. 15, 2022. Both the air recovery system and the water purification system have solar water collectors and salt recovery systems are described further in the Detail Description of the Embodiments of the_invention.

FIG. 3 is a block diagram illustrating the water purification system. The system depicts seawater pumped through a suction filter through a salvage water pump into a stowage tank. The seawater is transferred into the atmospheric tank heat exchanger. Having a vertical vacuum tank assembly and receiving a constant rate of hot seawater supplied from the atmospheric tank assembly. Furthermore, encompassing the solar water collector recirculating the water source to lower the temperature inside the vacuum tank assembly. Once you have adequate vacuum pressure and temperature inside the vacuum tank assembly the hot water vapor is pumped out of the vacuum tanks assembly by the CP-150 CLAWVAC vacuum pump and pumped back into the atmospheric tank assembly where the heat exchangers hot water vapor increases the temperature of the cold water inside the copper tubes and when doing so changes the hot water vapor state back into to a liquid state. After the hot water vapor condenses back into water and settles in the fresh water collector and is pumped into the clean tank assembly. The fresh water continues to be transferred into the clean stowage tank for pH7 level testing. Later the water is pumped into the UN-compliant tank (transferable stowage water tank). A similar process is initiated with the salt recovery system 800. The 1 Torr vacuum pump is turned on removing the atmosphere down to 1 Torr. Then the after the vacuum pressure has been reached and hot vapor water has been initiated, the CP-150 CLAWVAC vacuum pump ball valve is opened and the 1 Torr vacuum pump ball valve is closed and turned off. The process of removing hot water vapor and transferring the hot water vapor through the CP-150 CLAWVAC vacuum pump back into the atmospheric tank heat exchanger where the hot water vapor is cooled and condenses back into water. The water is then pumped into the clean tank assembly.

FIG. 4 is a block diagram illustrating the air recovery system. The water purification system atmospheric tank providing seawater to a larger horizontal vacuum tank called the atmospheric vacuum tank assembly. The atmospheric vacuum tank assembly encompasses dual heating elements with thermostats that control the temperature of the water inside the chamber. And a liquid level indicator determines the amount of water needed, a temperature probe is used to determine the temperature readings and vacuum relief valve needed to maintain the vacuum pressure and (2) two vacuum sight windows for viewing inside the vacuum chamber. The water pump provides seawater to both ends of the vacuum tank and provides a constant flow rate of seawater flowing through a ball valve, 10-micron filter and regulated that controls the flow entering the vacuum chamber. Once the water level is above the heating elements electrical power is turned on heating up the water to a determined temperature. The 1 Torr high vacuum pump initiates in pulling the pressure down to l Torr by removing the atmosphere. Then thereafter the vacuum pressure has been reached and hot vapor water has been initiated, the CP-150 CLAWVAC vacuum pump ball valve is opened slowly and the 1 Torr vacuum pump ball valve is closed. Then the process of removing hot water vapor and transferring the hot water vapor through the CP-150 CLAWVAC vacuum pump, ball valve and silencer into the atmosphere. The Leybold silencers reduces the sound level to approximately 40 decibels (dbA). Current recommendations are advised not to exceed more than 90 (dbA) permissible noise exposures for 8 eight hours per day per standard engineering data ABSI-API-ASTM-ISO-JIC-NEMA-NFPA-SAE-SI. Air Hydraulic systems Inc.

The solar water collector is attached to the atmospheric vacuum tank to assist in lowering the temperature of the seawater inside the vacuum chamber. A solar water pump is provided to recirculate the seawater inside the vacuum chamber.

The salt recovery system is attached to the brine tank. The ball valves are open going to the salt recovery system allowing the brine solution to enter the salt recovery chamber. The 1 Torr vacuum pump is turned on removing the atmosphere down to 1 Torr. Then after the vacuum pressure has been reached and the temperature has been determined, hot water vapor has been initiated, the CP-150 CLAWVAC vacuum pump ball valve is opened and the 1 Torr vacuum pump ball valve is closed, then the process of removing hot water vapor and transferring the hot water vapor through the CP-150 CLAWVAC vacuum pump, ball valve and silencer into the atmosphere.

FIG. 5 Illustrates an isometric view of the overall general arrangement of the air recovery system and the associated components.

FIG. 6 illustrates another perspective view of the air recovery system general arrangement rotated showing associated components.

FIG. 7 illustrates an isometric view of the arrangement of the exhaust components for the CP-150 CLAWVAC pump warm up and releasing the hot water vapor into the atmosphere.

FIG. 8 illustrates as isometric view of the atmospheric vacuum tank connected to the CP-150 CLAWVAC vacuum pump inlet for removing hot water vapor.

FIG. 9 illustrates an isometric view of the piping connections from the water purification brine tank and the portable brine tank container connected to the salt recovery system.

FIG. 10 illustrates an isometric view of the salt recovery connected to the atmospheric vacuum tank assembly and the portable brine tank container ball valve.

FIG. 11 illustrates an isometric view of the solar collector water pump connected to the atmospheric vacuum tank assembly.

FIG. 12 illustrates an isometric view of the front side of the atmospheric vacuum tank assembly encompassing (2) two heating elements, (2) two thermostats, one 1 Torr vacuum pump, water exhaust stowage tank and brine tank components located on the atmospheric vacuum tank assembly.

FIG. 13 illustrates an isometric view of the components on the rear view of the atmospheric vacuum tank assembly encompassing the water pump piping connections supplying seawater to both ends of the vacuum tank. The relief valves and quick disconnects fittings and ball valves associated with the brine tank. Also, the solar water collector piping connections and water pump going to and from the vacuum tank assembly.

The figures are not intended to be exhaustive or to limit the invention to precise from disclosed. It should be understood that the invention can be practiced with modification and alteration, and the invention be limited only by the claims and the equivalents thereof.

### DETAIL DESCRIPTION OF THE EMBODIMENTS OF THE INVENTION

The present invention as described herein is in terms of example environments. Description in terms of these environments is provided to allow the various features and embodiments of the invention to be portrayed in the context of an exemplary application. After reading this description, it will become apparent to one of ordinary skill in the art how the invention can be implemented in different and alternative environments.

Unless defined otherwise, all technical and scientific terms used herein have the same meaning as is commonly understood by one of ordinary skill in the art to which this invention belongs. All patents, applications, published applications and other publications referred to herein are incorporated by reference in their entirety. If a definition set forth in this section is contrary to or otherwise inconsistent with a definition set forth in applications, published applications and other publications that are herein incorporated by reference, the definition set forth in this document prevails over the definition that is incorporated herein by reference.

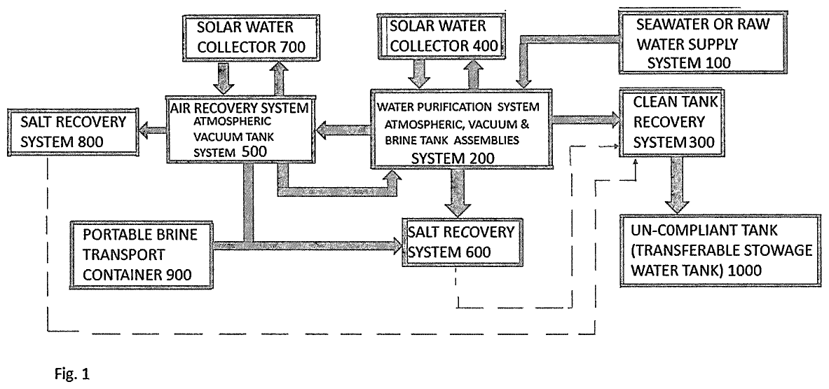

Referring to FIGS. 1-12 and 13, the air recover system includes a water source, seawater or raw water supply system 100 configured to be connected to a water purification system 200, clean tank assembly 300, a solar water collector 400, an atmospheric tank assembly 500, a salt recovery system 600, a solar water collector 700, a salt recovery system 800, a portable transport container 900 and un-compliant tank (transferable stowage water tank) 1000.

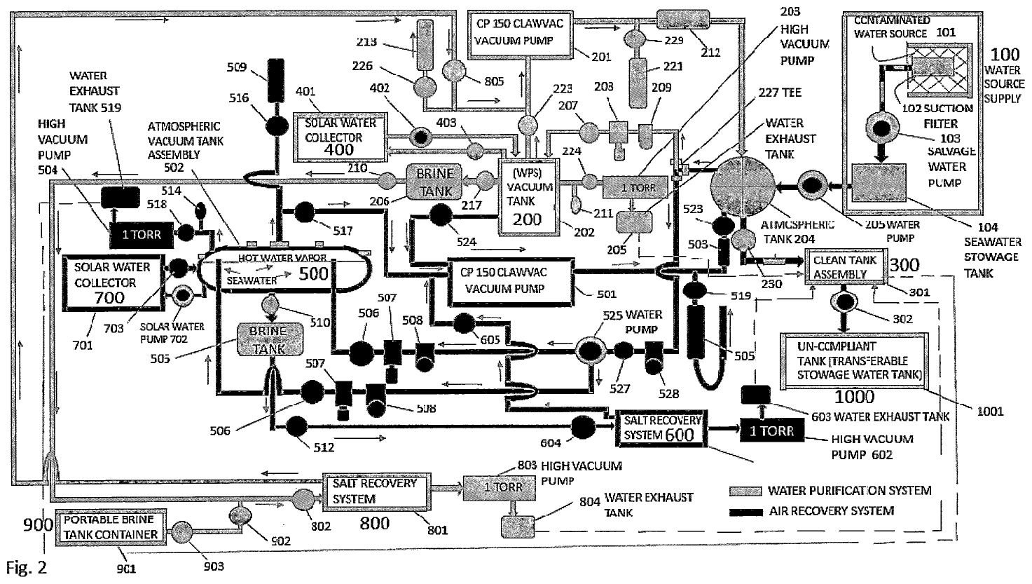

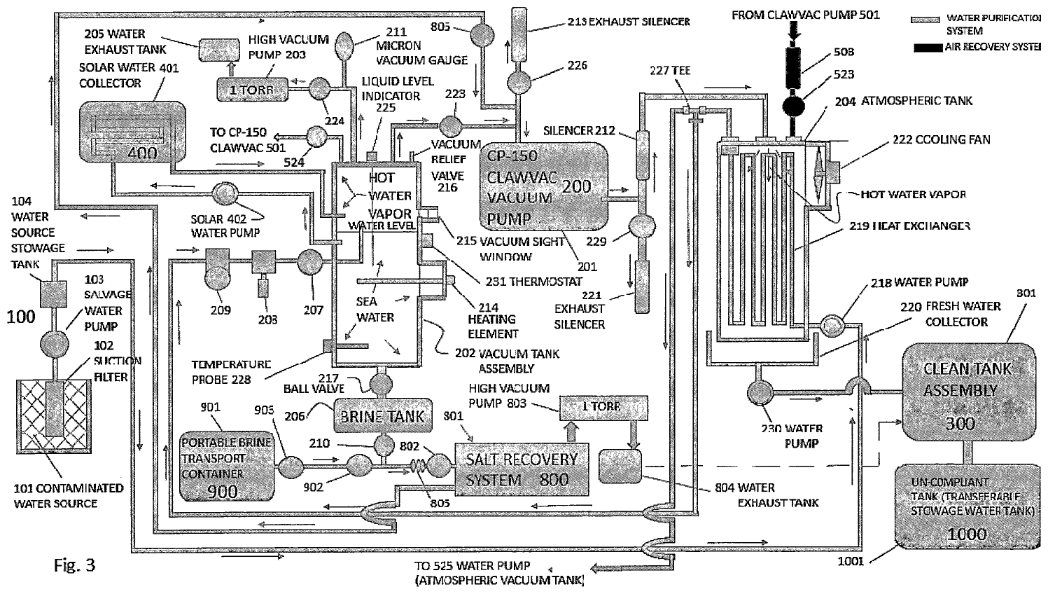

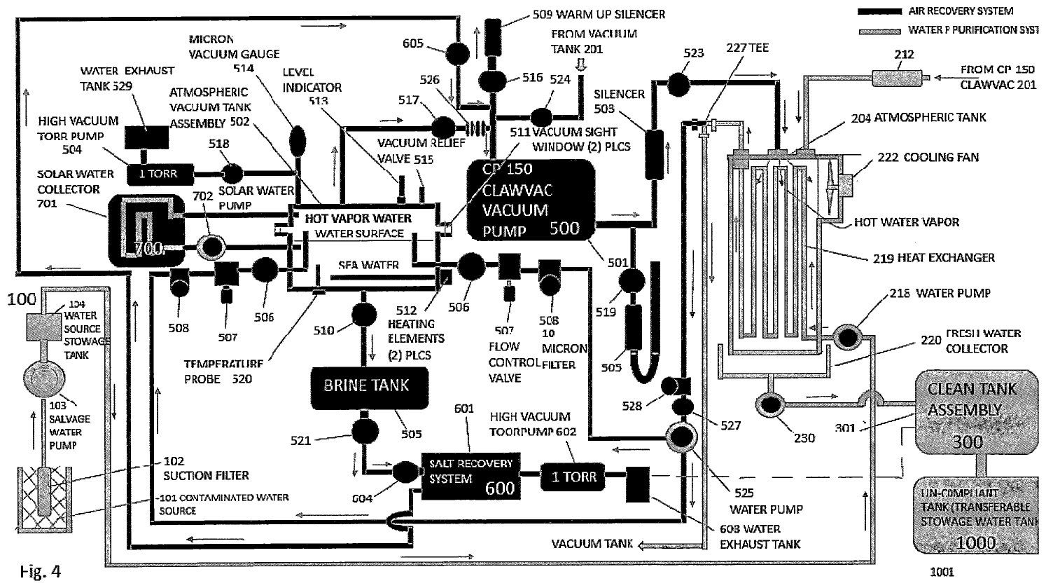

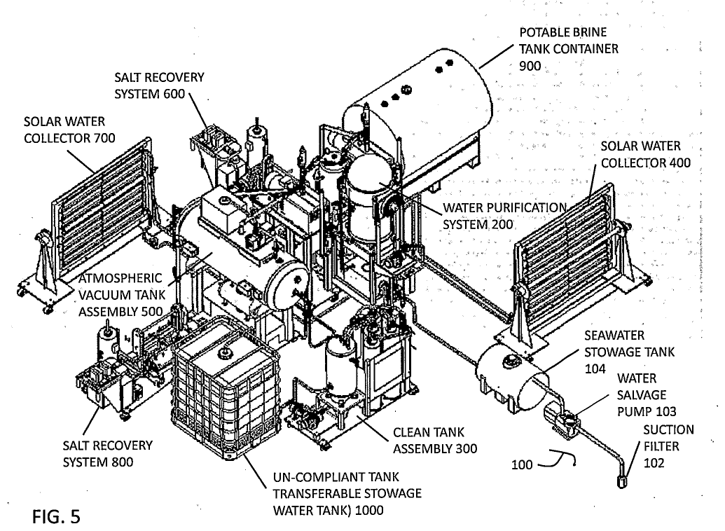

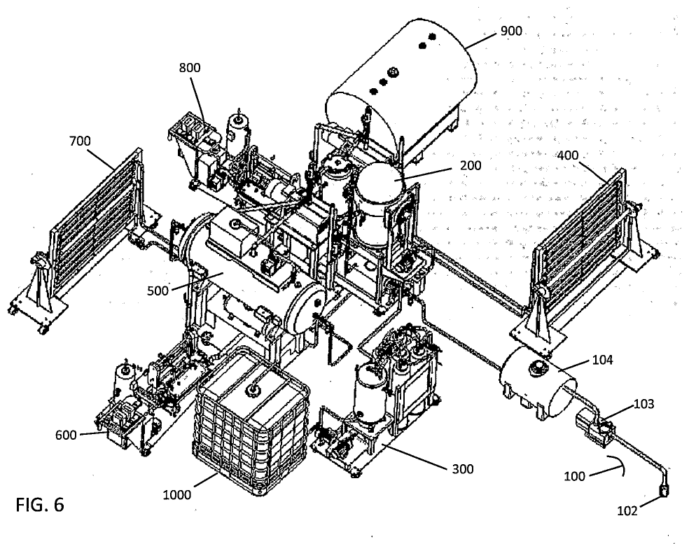

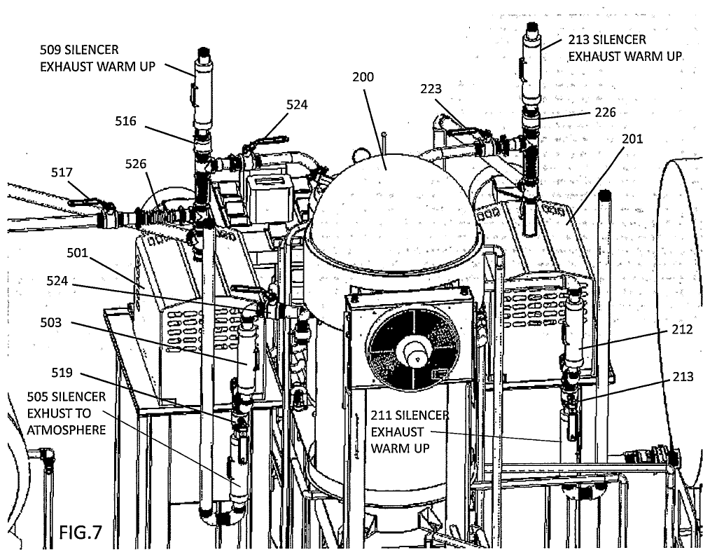

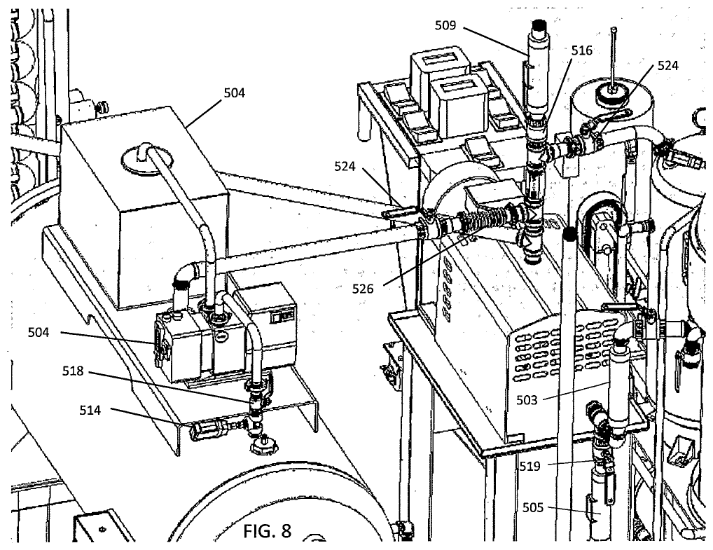

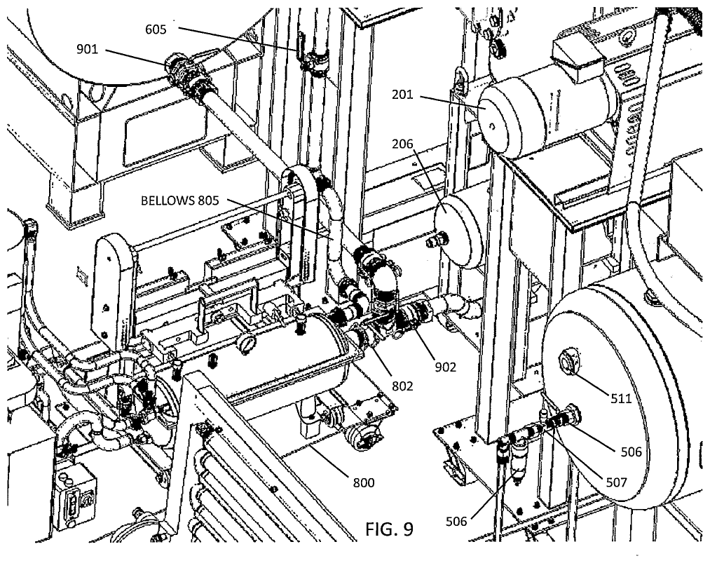

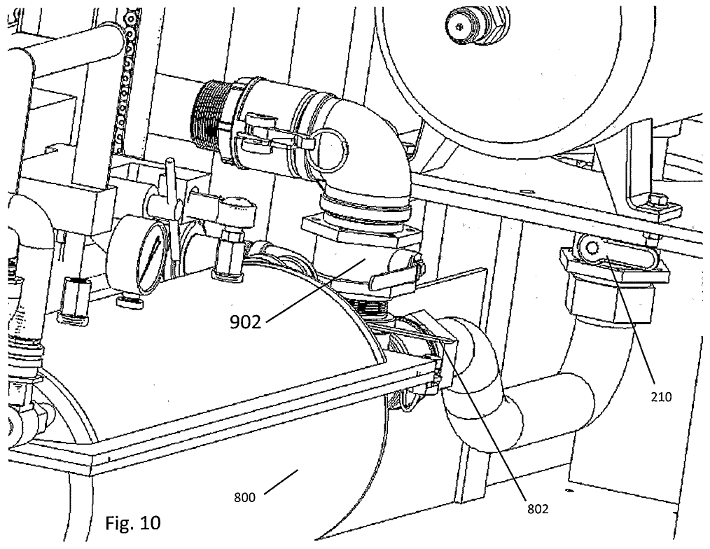

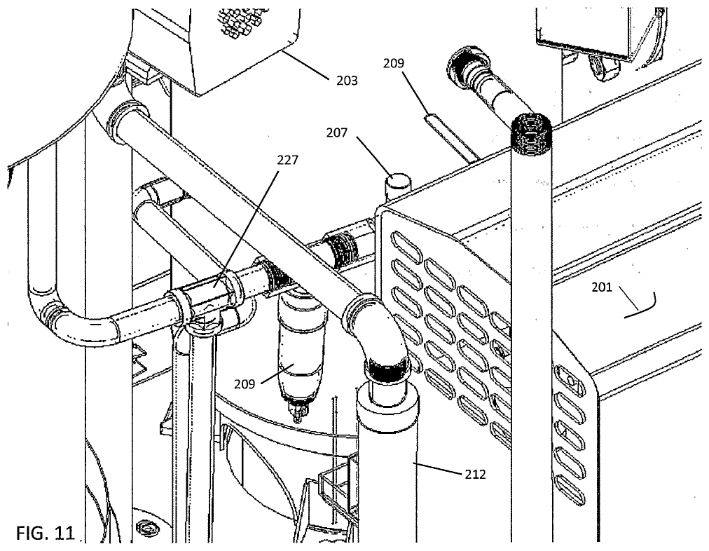

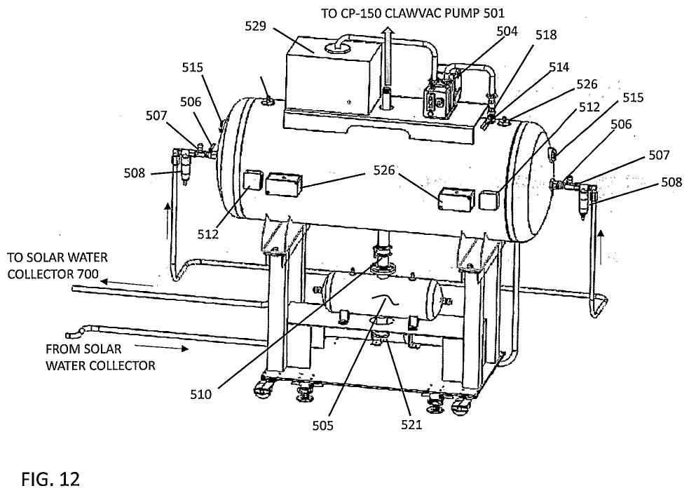

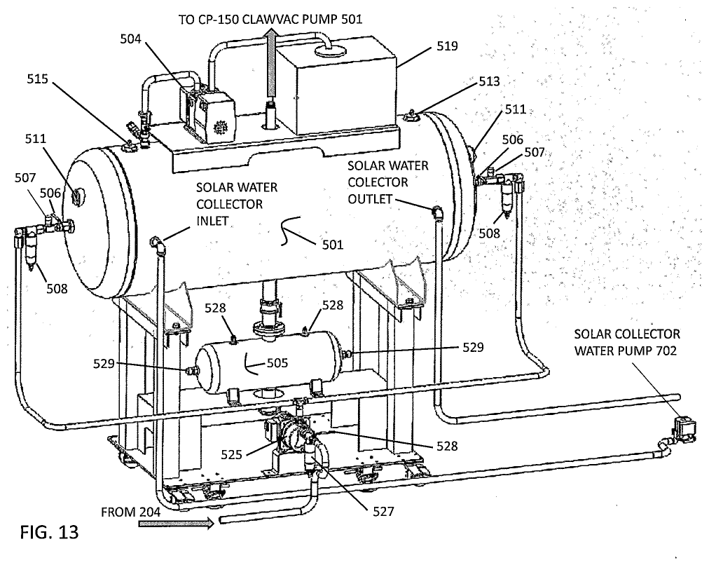

FIG. 2 block diagram illustrates the application for the water purification system combined with the air recovery system. Some additional components have been added to the water purification system not addressed in the patent that provides an operational air recovery system. The following description address the basic operations a more detailed description will be addressed in FIG. 3 and FIG. 5.

The water purification system encompasses a suction filter 102, salvage water pump 103, water source stowage tank 104, a water pump 205, atmospheric tank 204, vacuum tank assemblies 202 with a secondary high 1 Torr vacuum pump 203, a CP-150 CLAWVAC vacuum pump 201 and a brine tank 206, solar water collector 401, salt recovery system 800 and a clean tank assembly 300 all these components are needed to achieve clean water. Further description of water purification system is obtained in patent description {0002}.

The water purification system salvage pump 103 draws water from the contaminated water source 100. The salvage water pump 103 removes the water source supply 101 through a suction filter 102 into and by the salvage pump 103 and into a stowage tank 104. In some embodiment of the present invention, a suction filter 102 such as a 10-micron inline filter, for example located below the water surface upstream of the salvage pump 103 and is configured for preventing particles in the water source that are larger than a predetermined size (e.g., 10 microns) from entering the system 100. The water SOURCE continues to be pumped with water pump 205 located on and through the atmospheric tank 204. The source water is heated up by the heat exchanger inside the atmospheric tank. The heated water leaving the heat exchanger is separated into two different pathways by the 227 Tee, one going to the water purification vacuum tank 202, in the other direction seawater flows to the air recovery water pump 525. Both systems can be activated at the same time. First considering the water purification system 200 where the water flows through the 10-micron filter 209, flow control valve 208 and the ball valve 207. The water level is determined by liquid level indicated 225. The water is heated by the heating element inside the vacuum chamber tank 202 using the thermostats 231 to control the temperature shown in FIG. 11. The vacuum tank 202 encompass a 1 Torr high vacuum pump 203 which is turned on removing the atmosphere to approximately l Torr or 0.1 micron. Once the atmosphere and the temperature has been determined hot water vapor is created. The 1 Torr high vacuum pump ball valve 224 is closed still allowing the AAVAC micron vacuum gauge 211 to read the vacuum pressure. Once the vacuum pressure has been determined the l Torr vacuum pump ball valve 224 is turned off and the CP-150 CLAWVAC ball valve 223 is opened slowly transferring the hot water vapor through the CP-150 CLAWVAC vacuum pump 201 releasing hot water vapor through an inline silencer 212 into the atmospheric tank 204 on to the heat exchanger where the hot water vapor is cooled by the cold seawater inside the tubes and condenses back into water. The water pump 230 pumps the fresh water from the fresh water collector 220 into the clean tank assembly 300.

In some embodiments of the present invention, warming up the CP-150 CLAWVAC vacuum pump 201 for ten minutes before using. Close valves 208, 805, 223 associated with the vacuum tank 202 and open ball valves 229 and 226 and rum the CP-150 CLAWVAC vacuum pump. After warm up close valves 221 and 226 and open 223 slowly allowing the hot water vapor to be removed. The CP-150 CLAWVAC vacuum pump 201 pumps the hot water vapor thorough ball valve 223 and through the silencer 212 into atmospheric tank 204. The hot water vapor used to heat the cold seawater inside the heat exchanger, by doing so causes the temperature of the water to condense into liquid water. The water pump 230 pumps the liquid water into the clean tank assembly 301. At the clean tank is where the pH 7 inspection levels are taken. After inspection the water pump 302 pumps the water into the UN-compliant tank (transferable stowage water tank) 1000.

In some embodiments of the present invention further comprises a salt recovery system 800 used to recover salt from the brine solution. The 217-ball valve is closed above the brine tank 206 and the ball valve 210 below the brine tank 206 is open and the ball valve 802 is open allowing the brine solution to enter the salt recovery chamber 801. The brine solution inside the brine tank 206 is heated to a desired temperature or within a desired range of temperatures when has been reached then the 1 Torr vacuum pump 803 is turned on removing the atmosphere inside the chamber to 10 mbar allowing hot water vapor to be created. Then the 50 mbar CP-150 CLAWVAC vacuum pump 202 ball valve 805 is opened allowing the hot water vapor to be removed and recycled back to the atmospheric tank 204. The hot water vapor pulled out by the 1 Torr vacuum pump 803 is pumped into water exhaust tank 804 where the water can be recirculated back on the atmospheric tank. Further description of the salt recovery system can be obtained from the patent U.S. Pat. No. 11,331,592 B1 May 17, 2022.

In some embodiment of the present invention, the water is directed to the vacuum tank 202 via the water line from the solar water collector 400 into the vacuum tank 202. In such an embodiment, the water pump 402 is along the water line leading to the solar collector 401 from the vacuum tank assembly 202. When the solar water collector 400 requires maintenance turn water pump 402 off and close ball valve 403, before draining system. The heated water from the solar collector circulates through the vacuum tank assembly 202 assisting in raising the water temperature inside the vacuum tank and reducing the electrical energy consumption.

In some embodiments of the present invention, the air recovery system water source is also pumped by the salvage pump 103 draws water from the contaminated water source 100 through the suction filter 102. The water source uses the salvage pump 103 to pump the water source into the water stowage tank 104. The water source continues to be pumped into the atmospheric tank 204 where the water source is heated by the hot water vapor in the heat exchanger and continues flowing to the 227-pipe tee into water pump 525 located on the atmospheric vacuum tank assembly 502. The water pump 525 pumps to both ends of the vacuum tank 502 though both the 10-micron filters 508, flow control valves 507 and ball valves 506. The water tube represented in the block diagram enters the vacuum chamber 501 and is turned in the up positioned about the water surface allowing the water coming out to break the tension on the surface of the water. The water is heated to a desired temperature or within a desired range of temperatures, when has been reached the 1 Torr vacuum pump 504 is turned on bringing the atmosphere down inside the chamber to 10 mbar allowing hot water vapor to be created then the 50 mbar CP-150 CLAWVAC vacuum pump 501 ball valve 517 is opened slowly allowing the hot water vapor to enter the CP-150 CLAWVAC vacuum pump. The hot water vapor is then pumped thought the silencer 505 and exhausted into the atmosphere when the ball valve 519 is opened. In some embodiments of the present invention further comprises secondary method for recycling the hot water vapor back to the atmospheric tank 204 producing water. By closing the ball valve 519 and opening ball valve 523 will allow the hot water vapor to flow through the silencer and be recycled back to the atmospheric tank 204. The hot water vapor pulled out by the 1 Torr vacuum pump 803 is pumped into water exhaust tank 804 where the water can be recirculated back on the atmospheric tank.

In some embodiment of the present invention in the air recovery system, the water is directed to the vacuum tank 502 via the water line from the solar collector 700 into the vacuum tank 502. In such an embodiment, the water pump 702 is along the water line leading to the solar collector 701 from the atmospheric vacuum tank assembly 502. When the solar water 700 collector requires maintenance turn water pump 202 off and close ball valve 703, before draining system. The heated water from the solar collector circulates through the atmospheric vacuum tank assembly 502 assisting in raising the water temperature inside the vacuum tank and reducing the electrical energy consumption.

In some embodiments of the present invention further comprises a salt recovery system 601 used to recover salt from the brine solution. The ball valve 510 is closed above the brine tank 505 and the ball valve 512 below the brine tank 505 is open and the ball valve 604 is open allowing the brine solution to enter the salt recovery chamber 601. The brine solution inside the brine tank is heated to a desired temperature or within a desired range of temperatures when has been reached the 1 Torr vacuum pump 602 is turned on bringing the atmosphere down inside the chamber to 10 mbar allowing hot water vapor to be created then the 50 mbar CP-150 CLAWVAC vacuum pump 501 ball valve 605 and 523 is opened allowing the hot water vapor to flow through the 503 silencer and transferred back to the atmospheric tank 204.

In some embodiments of the present invention further comprises releasing the hot water vapor back into the atmosphere by opening ball valve 519 and closing ball valve 523, allowing the hot water vapor to flow through the 503 silencer and transferred back to the atmosphere. The hot water vapor pulled out by the 1 Torr vacuum pump 603 is pumped into water exhaust tank 604 where the water can be recirculated back on the atmospheric tank collector 220 shown in FIG. 3. Further description of the salt recovery system can be obtained from the patent U.S. Pat. No. 11,331,592 B1 May 17, 2022.

P FIG. 3 block diagram illustrates the application for the water recovery system. The water purification system described in the patent U.S. Pat. No. 11,247,927 B1. The primary reason for using water recovery system is for supplying heated water to both the vacuum tank 202 and the atmospheric vacuum tank assembly 502. The water purification system for creating water. The salvage water pump 103 is turned on pulling the contaminated water source 101 through the suction filter 102 then continues into the water source stowage tank 103. When filling the vacuum tank 202 with seawater refer to the liquid level indicator 225 and open ball valve 207 allowing seawater to flow into the vacuum chamber. The water pump 218 is turned on pumping seawater into the atmospheric tank 202 through the heat exchanger copper tubing 219. The heated seawater continues flowing the 227-Tee into the 10-micron filter 209, flow control valve 208 and the ball valve 207 into the vacuum chamber 202. The water source enters through a tube inside the chamber and is directed above the water surface. When the water flows out of the tube it breaks the tension on the water surface. Once the vacuum chamber 202 is full of seawater, turn on the electrical power to the heating element 214 and bring the desired temperature or within a desired range of temperatures until the temperature has been reached with the temperature probe 228. Then open ball valves 226 and ball valve 229 and turn on the CP-150 CLAWVAC vacuum pump to warm up. During the warm up the atmosphere is pulled through the exhaust silencer 213, ball valve 226 and into the CP-150 CLAWVAC vacuum pump 201. The CP-150 CLAWVAC pump exhaust the atmosphere through ball valve 229 and the exhaust silencer 221. After the CP-150 CLAWVAC vacuum pump runs for ten minutes close ball valve 229. With the 223-ball valve closed open ball valve 224 and turn on the 1 Torr high vacuum pump. Also turn on the 211 vacuum micron gauge and read the vacuum pressure. When the vacuum pressure reaches 10 mbars open the ball valve 233 slowly allowing the hot water vapor to be removed by the CP-150 CLAWVAC vacuum pump 201 and close ball valve 226. The close ball valve 224 and turn off the 1 Torr high vacuum pump 203. The hot water vapor will continue through the silencer 212 into the atmospheric tank 204 discharging a temperature of 258-degree Fahrenheit onto the copper tubes 219 located inside the atmospheric tank 204. At the same time the hot vapor water is cooled by the cold seawater circulating thru the copper tubes transferring the hot water vapor back into fresh water. The fresh water is collected at the bottom of the atmospheric tank 204 in the fresh water collector 220. The hot water vapor that has heated up the water source or seawater inside the copper tubes continues flowing into the vacuum chamber 202. The water pump 218 remains on and the water flow into the vacuum tank 202 is regulated by adjusting by the flow control valve 207 (located before entry to the vacuum tank 202 which is set at a desired flow rate (for example 9.8 oz. per minute) while the water flows into the vacuum tank 202. Depending on the water vaporization rate you can adjust the flow control valve by looking through the vacuum sight window 215. The hot water vapor continues flowing into the atmospheric tank 204 and this cycle continues. The salt recovery system 800 and the solar water collector 400 has been defined in paragraph {0034}.

To process the brine solution inside the portable brine transport container 900 open ball valves 901 and 902 and ball valve 802 forward to entering the salt recovery system tank 801. Close ball valve 210 located at the bottom of the brine tank. Allow the brine solution to flow into salt recovery tank 801. Controlling the amount of brine solution entering the salt recovery tank 801 can be accomplished by closing the 802-ball valve when the brine reaches the recommended level by lifting the lid on the salt recovery system 800.

FIG. 4 block diagram illustrates the application for the air recovery system. In some embodiments of the present invention, the air recovery system creates hot water vapor and can produce water. The salvage water pump 103 is turned on pulling the contaminated water source 101 through the suction filter 102 then continues into the water source stowage tank 104. Depending how far the water source additional salvage pumps and stowage tanks form the water source may be added. The water pump 218 is turned on pumping seawater into the atmospheric tank 204 and continues being pumped into and through the heat exchanger copper tubing 219. The seawater continues flowing through the 227-pipe tee where the seawater is diverted to both the vacuum tank 202 and atmospheric vacuum tank pump 525. The water pump 525 is located at the bottom the atmospheric vacuum tank assembly 502. The water pump 525 separates the flow in two directions one at each end of the vacuum tank 502. The atmospheric vacuum chamber water surface area 502 is approximately (8) eight time larger than the vacuum tank 202 therefore provides additional hot water vapor released into the atmosphere. When filling the vacuum tank 502 with seawater open both 506 ball valves located at the ends of the vacuum tank 502 allowing the seawater to flow through both 10-micron filters 508, flow control valves 507 and ball valves 506. The Innovative liquid level indicator 513 provides adequate reading of the seawater level inside the tank. The seawater or water source enters through a tube inside the chamber 502 and extends up about the water surface. The water coming out of the tube extending above the water surface falls onto the surface breaking the water tension assisting in the vaporization process. When the water temperature increases high enough the heating elements create air bubbles that rise to the surface and break the water tension as well. Once the vacuum chamber 502 is full of seawater, turn on the electrical power to the heating element 512 and bring the desired temperature or within a desired range until the temperature has been reached with the Innovative temperature probe 520.

In some embodiments of the present invention, warming up the CP-150 CLAWVAC vacuum pump 501 for ten minutes before using. Close ball valves 517, 523 and 605. Open ball valves 516 and ball valve 519 associated with the vacuum tank 502. After warm up close valves 516 and 519 open 517 slowly allowing the hot water vapor to be removed. The atmosphere is pulled into the exhaust silencer 509, ball valve 516 and by the CP-150 CLAWVAC vacuum pump 501. The atmosphere is exhausted thru the ball valve 519 and the exhaust silencer 505. With the 517-ball valve closed open ball valve 518 and turn on the 1 Torr high vacuum pump. Also turn on the 514-micron vacuum gauge to determine the vacuum pressure. Close ball valve 518, 605 and 523. Turn off the 1 Torr high vacuum pump 504 when the vacuum pressure has reached 10 mbars. Open ball valve 519. And ball valve 517 slowly allowing the hot water vapor to be pumped out of the vacuum chamber 502 into the CP-150 CLAWVAC vacuum pump 501. The hot water vapor flows through the open ball valve 519 continues flowing through the silencer 505 into the atmosphere. The hot water vapor flowing out of the CP-150 CLAWVAC pump into the atmosphere is exhausted at an approximate rate based on the CP-150 CLAWVAC vacuum speed of 150/180 m³/h or approximately 6,356 ft³/h.

In some embodiments of the present invention, producing water from the hot water vapor is accomplished when removing hot water vapor from the atmospheric vacuum tank assembly 502. Open ball valve 517 slowly allowing the CP-150 CLAWVAC vacuum pump 501 to pump the hot water vapor out and through the silencer 503 and ball valve 523 into the atmospheric tank 204 discharging a temperature of 258-degree Fahrenheit onto the copper tubes 219 located inside the atmospheric tank 204. At the same time the hot vapor water is cooled by the cold seawater circulating thru the copper tubes 219 transferring the hot water vapor back into fresh water. The fresh water is collected at the bottom of the atmospheric tank in the fresh water collector 220. The hot water vapor that has heated up the seawater inside the copper tubes continues flowing into the vacuum chamber 502 reducing the energy needed for operating the heating elements 512. The water pump 218 continues pumping water to water pump 525. Water pump 525 maintains a constant pressure and water flow into the vacuum tank 502. The flow rate is regulated by adjusting both flow control valves 507 which is set at a desired flow rate (for example 53.5 oz. per minute) while the water flows into the vacuum tank 502 at both ends. Depending on the water vaporization rate you can adjust the flow control valve by looking through the vacuum sight window 511.

The electrical water pumps have an on/off manual switch which allows manual override of the control when systems 100 through 1000 shown in FIG. 1 are controlled by a central Processing Unit of a PLC. The systems 100 thru system 1000 in FIG. 1 can be operated manually or may be operated via an automatic control device. If the systems I FIG. 4 is operated by an automatic control device (e.g., a computer), electrical solenoid operated ball valves are used. An example of a solenoid operated ball valve is a ¾″ NPT solenoid valve 120/60 AC and a 110/503/4″ orifice, which may be purchased on Amazon. As mentioned above, the operation of the pumps may be dictated by water level control unit (e.g., float level indicators) included in all the vertical or horizontal tanks.

Although the invention is described above in terms of various exemplary embodiments and implementations, it should be understood that the various features, aspects and functionality described in one or more of the individual embodiment are not limited in their applicability to the particular embodiment with which they are described, but instead can be applied, alone or in various combinations, to one or more of the other embodiments of the inventions, whether or not such embodiments are described and whether or not such features are presented as being a part of a described embodiment. Thus, the breadth and scope of the present invention should not be limited by any of the above-described exemplary embodiments.

What is claimed is:

1. An air recovery system. comprising
a) Water purification system that provides hot water to atmospheric vacuum tank assembly.
b) Water purification system that connected to a portable salt recovery system.
c) A CP-150 CLAWVAC vacuum pump that receives hot water vapor from the atmospheric vacuum tank assembly and releases the hot water vapor to the atmosphere.
d) An atmospheric vacuum tank configured to be maintained at an atmospheric pressure and to generate the water vapor drawn by the high vacuum pump assembly on the vacuum tank.
e) A water pump that receives water from the salvage pump.
f) A water pump that cleans and regulates the supply of the water source to both ends of the atmospheric vacuum tank assembly through a 10 micron filter a flow control valve and a ball valve.
g) Having vacuum sight windows at both ends of the atmospheric vacuum tanks assembly.
h) A level indication to determine the amount of water inside the vacuum chamber.
i) A temperature probe to determine the temperature inside the vacuum chamber.
j) A vacuum relief valve to relieve the vacuum pressure for maintenance.
k) A first vacuum pump configured to lower the pressure inside the chamber of the atmospheric tank assembly.
l) A Vacuum micron gauge to measure the pressure inside the vacuum chamber of the atmospheric tank assembly.
m) An atmospheric vacuum tank assembly having a water surface area over fifteen times larger than the vertical vacuum water surface area.
n) An atmospheric vacuum tank assembly connecting to a salt recovery system for processing the brine solution.
o) A water purification system vacuum tank assembly connecting to a salt recovery system for processing the brine solution.
p) A portable brine transport container that connects in line to the salt recovery system.
q) The 227 Tee fitting providing access for hot water flowing to both the water purification vacuum tank assembly and the air recovery atmospheric vacuum tank assembly.

2. The air recovery system of claim 1, further comprising a second vacuum pump wherein:
The first vacuum pump is configured to lower the vacuum pressure inside the chamber of the atmospheric tank assembly to a first vacuum pressure and to extract the water vapor at first pumping speed.
The second vacuum pump is configured to maintain the pressure inside the atmospheric vacuum chamber at a second higher than the first vacuum pressure and to extract the water vapor at a second pumping speed higher than the first pumping speed;
The air recovery system comprises a first valve between the atmospheric vacuum tank assembly and the first vacuum pump, and a second valve between the atmospheric vacuum tank assembly and the second vacuum pump.
The first vacuum pump is configured to be operated with the first valve open to lower the pressure in the atmospheric tank vacuum tank assembly to the first pressure and to extract the water vapor from the atmospheric vacuum tank assembly at the first pumping speed for a predetermined time period, while the second vacuum pump is operated to warm up with the second valve closed.
At the end of the predetermined time period, the first valve is configured to be closed and the second valve is configured to be opened such that the second vacuum pump maintains the pressure within the atmospheric vacuum tank assembly at the second vacuum pressure and extract water vapor form the atmospheric vacuum tank assembly at the second pump speed.

3. A series of salvage water pumps and water stowage tanks for transferring the water source from one water pump and stowage tank to the next water pump and stowage tank depending on the distance from the water source.

4. Connecting to the atmospheric tank and to the atmospheric vacuum tank assembly water pump for supplying hot water to the vacuum tank chamber.

5. Connecting the CP-150 CLAWVAC vacuum pump to the atmospheric tank for supplying hot water vapor to produce water.

6. Connecting the CP-150 CLAWVAC vacuum pump to the atmospheric tank for supplying hot water vapor to the atmosphere.

7. The air recovery system of claim 1, further comprising a solar pump and a solar water collector, wherein: the solar pump is configured to drive water from an outlet of the atmospheric tank to an inlet of the solar collector, via the solar collector, via an outlet of the solar collector, and back into the atmospheric tank via an inlet of the vacuum tank; and the solar collector is configured for using solar power to heat the water flowing in the solar collector.

8. The air recovery system is configured to drive water from an outlet of the atmospheric vacuum tank chamber to an outlet of the solar collector, via the solar collector, via an outlet of the solar collector, and back into the vacuum tank chamber via an inlet of the vacuum tank chamber; and the solar collector is configured for using solar power to heat water following into the water heater.

9. The air recovery system of claim 1, wherein: the atmospheric vacuum tank assembly comprises of a brine tank located under the atmospheric tank and communicating with the vacuum tank via a first water line opened and closed via a top ball valve; top ball valve is configured to be open, to cause the brine collected at a bottom of the vacuum tank chamber to enter the brine tank.

10. The air recovery system of claim atmospheric tank and communicating with the atmospheric vacuum tank via a second water line opened and closed via a bottom ball valve; bottom ball valve is configured to be closed.

11. The air recovery system of claim 2, wherein the atmospheric vacuum tank assembly comprising a salt recovery system located under an outlet of the brine tank: wherein: the outlet of the brine tank is configured to be open and closed and closed the bottom valve; the bottom valve is configured to be open, and the entry valve to salt recovery to be opened, to cause the brine collected in the brine tank to enter the salt recovery tank.

12. The salt recovery system of claim 3, wherein the salt recovery system is removable from under the outlet of the brine tank.

13. The water purification system of claim 1, wherein the salt recovery system is removable from under the outlet of the brine tank.

14. The brine tank having (2) two quick disconnects located at each end of the tank for cleaning out the salt inside the brine tank.

15. The brine tank having (2) two relief valves.

16. The air recovery CP-150 CLAWVAC pump connected to the water purification tank for creating water.
